(19) United States
(12) Patent Application Publication
(10) Pub. No.: US 2006/0190447 A1
(43) Pub. Date: Aug. 24, 2006

(54) Query spelling correction method and system

(75) Inventors: Justin Harmon, Los Angeles, CA (US); Kyle G. Peltonen, Issaquah, WA (US); Shajan Dasan, Sammamish, WA (US)

Correspondence Address: MERCHANT & GOULD PC, P.O. BOX 2903, MINNEAPOLIS, MN, 55402-0903, US

(73) Assignee: Microsoft Corporation, Redmond, WA (US)

(21) Appl. No.: 11/064,405

(22) Filed: Feb. 22, 2005

(51) Int. Cl. G06F 17/30

(52) U.S. Cl. 707/4; 707/3

(57) ABSTRACT

A method and system for providing to a user a set of alternative query suggestions is disclosed. The method, system and computer readable medium product in accordance with embodiments of the invention includes generating an index of all words in a corpus of documents available to the application, generating a popularity table for the index having a popularity value for each word in the index based on occurrences of the word in the corpus, comparing each entry in the popularity table to suggestions from a word generator, compiling a lexicon of word generator suggestion words that are found in the popularity table, submitting each word in the search query to the word generator to determine suggestion words, and displaying to the user one or more of the suggestion words from the lexicon that are more popular than the query word.

### FIELD OF THE INVENTION

This application relates generally to computer software and more particularly to a method and system for proposing to a user alternative query word spellings during queries in an application.

### BACKGROUND OF THE INVENTION

Users sometimes make spelling mistakes when issuing a search query in an application or on an operating system. Often the search engine does not detect these misspellings. The user may not realize the mistake, and perceives the search engine as bad. Further, users may not find the documents they were looking for. One way of solving this problem is to use a word generator—like the Microsoft® Office word generator—to detect misspellings. The corrected words can be displayed back to the user as alternate query suggestions.

It is with respect to these and other considerations that the present invention has been made.

### SUMMARY OF THE INVENTION

In accordance with the present invention, the above and other problems are solved by a system for handling queries in an application in which each query word is analyzed, and popular alternatives are provided as suggestions to the user based on prevalence, i.e. popularity of the word's usage in the corpus of documents available to the application. This system also includes a word generator which provides similar spellings to a query word, an index of all words occurring in the corpus of documents available to the application, a popularity table that provides a popularity, i.e. relevance, value accorded to each entry in the index, and a lexicon of word generator words that appear in the popularity table.

The method in accordance with embodiments of the present invention for generating query suggestions to a user during a query in an application includes analyzing each word in a query with a word generator to determine suggestion words, comparing each word suggestion obtained from the word generator to entries in a popularity table of words to determine popular suggestion words, and displaying to the user one or more of the suggestion words that are more popular than the query word. The analyzing operations comprise generating an index of all words in a corpus of documents available to the application and generating the popularity table having a popularity value for each word in the index based on occurrences of the word in the corpus.

More particularly, the method, system and computer readable medium product in accordance with embodiments of the invention includes generating an index of all words in a corpus of documents available to the application, generating a popularity table for the index having a popularity value for each word in the index based on occurrences of the word in the corpus, word generator compiling a lexicon of word generator suggestion words that are found in the popularity table, submitting each word in the search query to the word generator to determine suggestion words, determining the popularity value for each suggestion word from the word generator from the popularity table, and displaying to the user one or more of the suggestion words from the lexicon that are more popular than the query word.

The invention may be implemented as a computer process, a computing system or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

A more complete appreciation of the present invention and its improvements can be obtained by reference to the accompanying drawings, which are briefly summarized below, and to the following detailed description of presently preferred embodiments of the invention, and to the appended claims.

### BRIEF DESCRIPTION OF THE DRAWINGS

FIG. 1 illustrates an exemplary alternate query suggestion system according to an embodiment of the present invention.

FIG. 2 shows a computer system environment that may incorporate software operating according to particular aspects of the present invention.

FIG. 3 illustrates a more detailed diagram of the alternate query suggestion system shown in FIG. 1.

FIG. 4 is a process flow diagram of operation of the embodiment shown in FIG. 1.

### DETAILED DESCRIPTION OF THE INVENTION

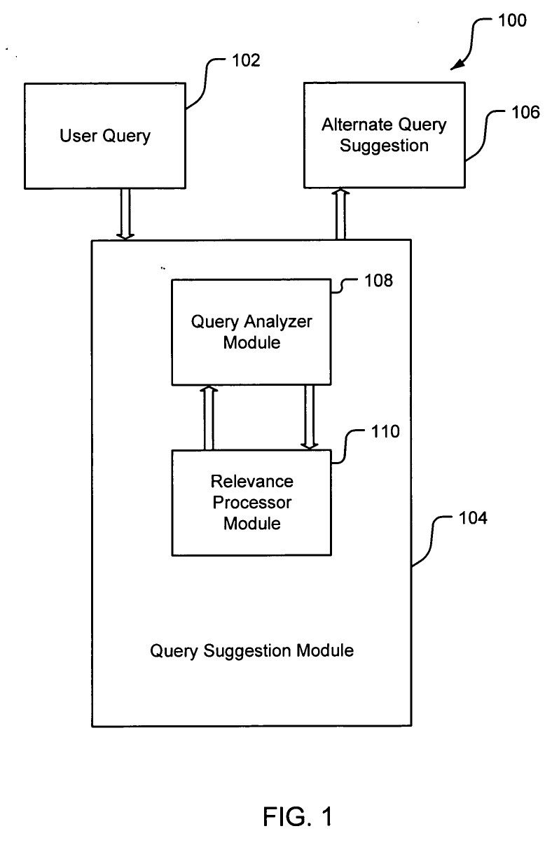

The present invention will now be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In accordance with embodiments of the invention, the methods described herein may be performed on a single, stand-alone computer system but are more typically performed on multiple computer systems interconnected to form a distributed computer network. FIG. 1 illustrates one embodiment of a query suggestion system 100 in accordance with the present invention. The system 100 may be operable in any software application or operating system. The system receives a user query 102 and passes that query to a search engine (not shown) in a conventional manner. At the same time, the user query 102 is passed to a query suggestion module 104. The query suggestion module 104 receives the user query 102, analyzes the query and, under certain conditions, discussed more fully below, provides to the user alternate query suggestions 106 that the user might choose to utilize.

The query suggestion module 104 basically comprises two modules: a query analyzer module 108 and a relevance processor module 110. The query analyzer module 108 feeds the query to the relevance processor module in order to get relevance information regarding potential alternate query words. These alternate query words and their relevance are then fed back to the query analyzer 108, which then determines whether or not to provide one or more alternate query suggestions 106.

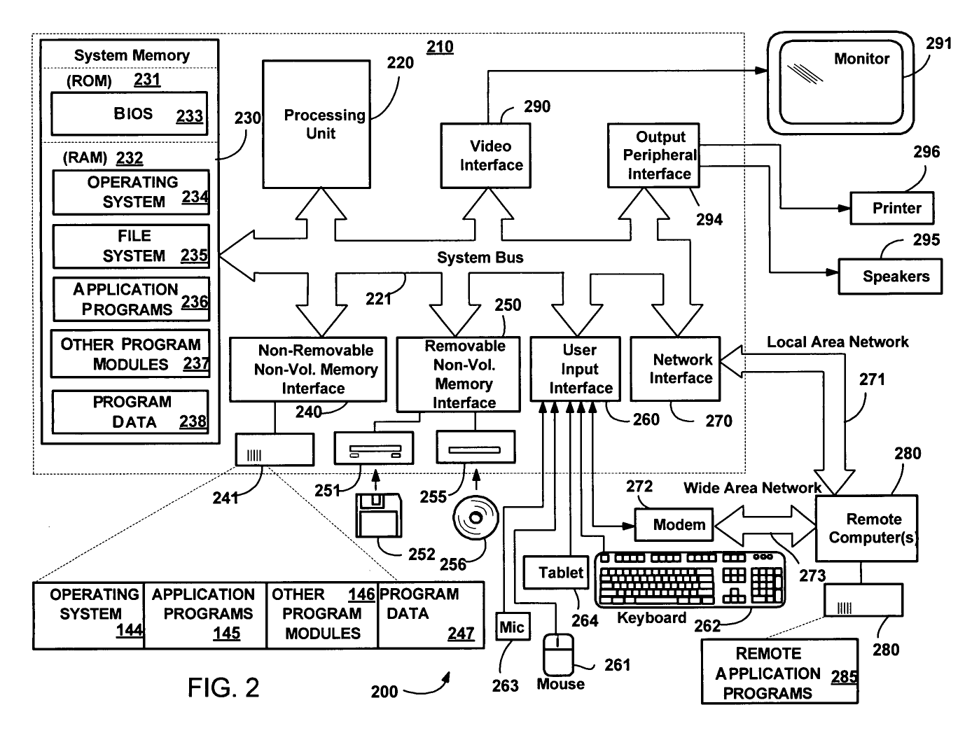

FIG. 2 illustrates an exemplary environment 200 for implementing an embodiment of the invention. This environment 200 includes a general purpose computing device in the form of a computer 210. Components of the computer 210 may include, but are not limited to, a processing unit 220, a system memory 230, and a system bus 221 that couples various system components including the system memory to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Accelerated Graphics Port (AGP) bus, and Peripheral Component Interconnect (PCI) bus also known as Mezzanine bus.

The computer 210 typically includes a variety of computer-readable media. Computer-readable media can be any available media that can be accessed by the computer 210 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 210. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

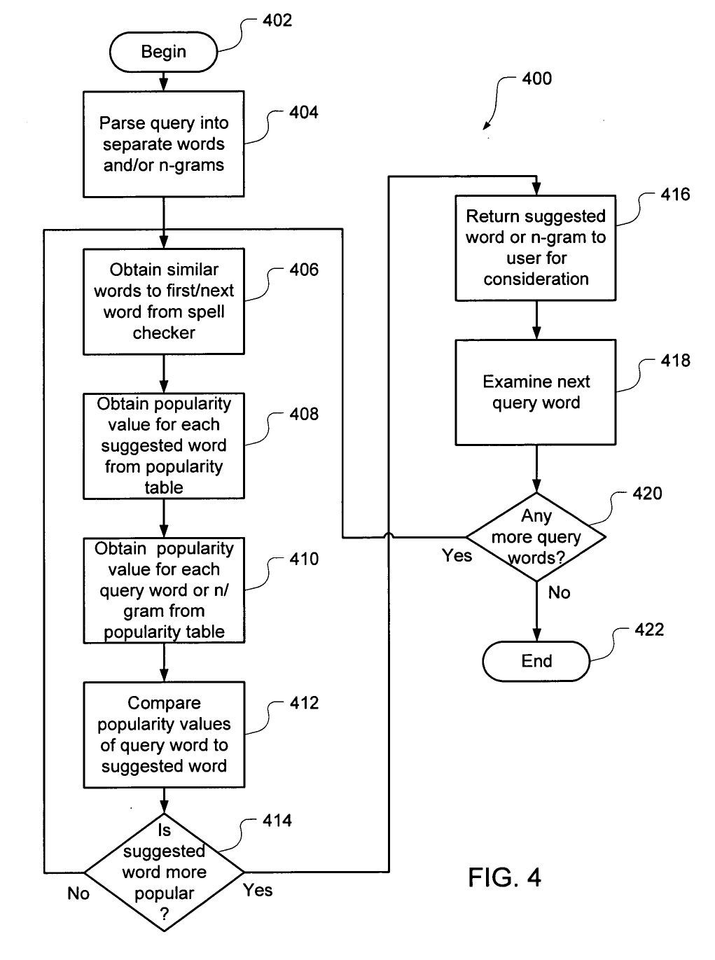

The system memory 230 includes computer storage media in the form of volatile and/or nonvolatile memory such as read only memory (ROM) 231 and random access memory (RAM) 232. A basic input/output system 233 (BIOS), containing the basic routines that help to transfer information between elements within computer 210, such as during start-up, is typically stored in ROM 231. RAM 232 typically contains data and/or program modules that are immediately accessible to and/or presently being operated on by processing unit 220. By way of example, and not limitation, FIG. 4 illustrates operating system 234, application programs 235, other program modules 236 and program data 237.

The computer 210 may also include other removable/non-removable, volatile/nonvolatile computer storage media. By way of example only, FIG. 2 illustrates a hard disk drive 241 that reads from or writes to non-removable, nonvolatile magnetic media, a magnetic disk drive 451 that reads from or writes to a removable, nonvolatile magnetic disk 452, and an optical disk drive 255 that reads from or writes to a removable, nonvolatile optical disk 256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 251 and optical disk drive 255 are typically connected to the system bus 221 by a removable memory interface, such as interface 250.

The drives and their associated computer storage media, discussed above and illustrated in FIG. 2, provide storage of computer-readable instructions, data structures, program modules and other data for the computer 210. In FIG. 2, for example, hard disk drive 241 is illustrated as storing operating system 244, application programs 245, other program modules 246 and program data 247. Note that these components can either be the same as or different from operating system 234, application programs 235, other program modules 236, and program data 237. Operating system 244, application programs 245, other program modules 246, and program data 247 are given different numbers herein to illustrate that, at a minimum, they are different copies. A user may enter commands and information into the computer 210 through input devices such as a tablet (electronic digitizer) 264, a microphone 263, a keyboard 262 and pointing device 261, commonly referred to as mouse, trackball or touch pad. Other input devices (not shown) may include a joystick, game pad, satellite dish, scanner, or the like. These and other input devices are often connected to the processing unit 220 through a user input interface 160 that is coupled to the system bus, but may be connected by other interface and bus structures, such as a parallel port, game port or a universal serial bus (USB). A monitor 291 or other type of display device is also connected to the system bus 221 via an interface, such as a video interface 290. The monitor 291 may also be integrated with a touch-screen panel 293 or the like that can input digitized input such as handwriting into the computer system 210 via an interface, such as a touch-screen interface 292. Note that the monitor and/or touch screen panel can be physically coupled to a housing in which the computing device 210 is incorporated, such as in a tablet-type personal computer, wherein the touch screen panel 293 essentially serves as the tablet 264. In addition, computers such as the computing device 210 may also include other peripheral output devices such as speakers 295 and printer 296, which may be connected through an output peripheral interface 294 or the like.

The computer 210 may operate in a networked environment using logical connections to one or more remote computers, such as a remote computer 280. The remote computer 280 may be a personal computer, a server, a router, a network PC, a peer device or other common network node, and typically includes many or all of the elements described above relative to the computer 210, although only a memory storage device 281 has been illustrated in FIG. 2. The logical connections depicted in FIG. 2 include a local area network (LAN) 271 and a wide area network (WAN) 273, but may also include other networks. Such networking environments are commonplace in offices, enterprise-wide computer networks, intranets and the Internet.

When used in a LAN networking environment, the computer 410 is connected to the LAN 271 through a network interface or adapter 270. When used in a WAN networking environment, the computer 210 typically includes a modem 272 or other means for establishing communications over the WAN 273, such as the Internet. The modem 272, which may be internal or external, may be connected to the system bus 221 via the user input interface 260 or other appropriate mechanism. In a networked environment, program modules depicted relative to the computer 210, or portions thereof, may be stored in the remote memory storage device. By way of example, and not limitation, FIG. 2 illustrates remote application programs 285 as residing on memory device 281. It will be appreciated that the network connections shown are exemplary and other means of establishing a communications link between the computers may be used.

With the computing environment in mind, embodiments of the present invention are described with reference to logical operations being performed to implement processes embodying various embodiments of the present invention. These logical operations are implemented (1) as a sequence of computer implemented steps or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

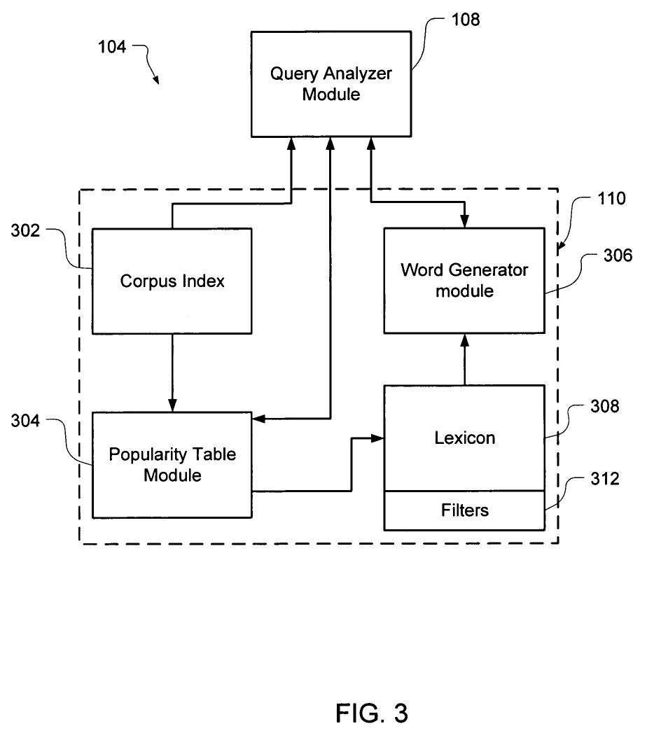

Turning now to FIG. 3, a more detailed modular diagram of the query suggestion module 104 is provided. The query analyzer module 108 draws information from three defined sources in the relevance module 110: a corpus index 302, a popularity table module 304, and a word generator module 306.

The corpus index 302 is basically a lexicon of all words that exist in a corpus (domain) of documents to which the application has access. Full text indexing is the process of extracting words out of documents and lexically arranging the words for fast lookup. Each word is associated with a list of documents that contained the word. This list of word to document set association is called the (inverted) index. The corpus index 302 is dynamic, and as documents are accessed by the calling application they may be added to the corpus such that it continually grows in size as the system 100 is used. The corpus index 302 includes words in all the languages in the corpus and includes n-grams as well as words. Each word/n-gram in the corpus of documents available to the application is associated with the document in which it is used. Thus each word is associated with a list of documents. This list is called an inverted index. In addition, each word may be associated with its frequency of use within a document. This frequency value is also contained for each word in the index 302.

The popularity table module 304 examines the corpus index 302 and compiles a popularity value associated with each word in the corpus index 302. This popularity value is also continually updated as new documents are added to, removed from or modified in the corpus of documents to which the calling application has access. The popularity value may be based on the number of times a particular word or n-gram appears in a document, the number of documents in the corpus that contain the word or n-gram, or the absolute number of times the word or n-gram appears in all the corpus documents in the aggregate. Preferably the popularity value is based on the number of corpus documents in which the word or n-gram appears, and is thus a measure of the frequency of word occurrence. Low frequency words are sometimes not added to the popularity list in order to keep the popularity list manageable in size.

The word generator lexicon 308 is built using the words in the popularity table module 304. The lexicon 308 has one or more filters 312 within it to filter out noise words. Noise words are words that appear so frequently that they contribute nothing to the query suggestion process. Such words are articles, prepositions etc. and connector words such as “and” and “or” in English, “und” in German or “y” in Spanish. The lexicon 308 thus draws words from the popularity table, filters out noise words, and the word generator module 306 uses the resulting list of words. Alternatively the filters 312 may be incorporated into the popularity table module 304. In either case, the filters 312 may operate to reject any words that have a frequency of occurrence above a predetermined value. A filter may also be provided to filter out those words that are extremely infrequently used.

The word generator module 306 draws from the lexicon 308. It analyzes the words in the lexicon 308 for similar spellings and syntax to the query word being examined in the query analyzer, and provides suggested words to the analyzer 108 based on similar spelling and/or syntax. The word generator module 306 is essentially a word generator or spell checker that generates a list of close spellings. A spellchecker that may be used as a word generator in embodiments of the present invention is the conventional Microsoft® Word SpellAPI to suggest close spellings of the query word, comparing the results to the lexicon 308 in order to generate the suggestions provided to the query analyzer module 108. Alternatively, there is a family of UNIX functions (grep, agrep, egrep, etc.) that generate words of similar spellings to a word being examined. For instance to search a directory for a word close in spelling to ‘airpalne’ one would write ‘agrep-e airpalne ’ and would expect to receive also files with the word ‘airplane’. In general, any approximate pattern-matching algorithm could be used to generate the similar words. One of these may also be used rather than a spellchecker as previously described.

FIG. 4 is an operational flow diagram of the operations 400 occurring in the query analyzer 108 in order to generate alternative suggestions to the user's query 102. The process 400 begins in operation 402 wherein a user query 102 is sensed. Control then passes to operation 404.

In operation 404, the query, which is usually two or more words, is tokenized into individual words or n-grams. Each word is individually analyzed in the below steps. It is to be understood, however, that, at this point, the query could also be parsed into two or three word groupings for analysis. The methodology would, in that case, be quite similar to the individual word approach described herein. In addition some of the frequencies of interest in the multi-word case may be the frequencies in which one word is likely to follow another, and not just the frequency of the phrase within the corpus. These frequencies may also be accommodated and evaluated. Once the query is tokenized, or parsed, into separate words, control transfers to operation 406.

In operation 406, the first/next word is examined. The analyzer calls the word generator module 306 and provides the word generator module 306 with the first word. The word generator module 306 then returns any close spellings of the first/next query word that exist in the lexicon 308 as query suggestion words. The analyzer 400 then transfers control to operation 408.

In operation 408, the popularity table module 304 is accessed and returns the popularity values for each of the query suggested words. Control then transfers to operation 410 where the popularity value for the first/next query word being examined is also provided to the analyzer 108. Control then transfers to operation 412.

In operation 412, the popularity value for the first/next query word is compared to each popularity value for the suggested alternative words. Control then transfers to query operation 414 where the question is asked whether there is a query suggestion word that is more popular than the user's first/next query word. If the popularity value for the user's first/next query word is greater than the popularity value of the suggested word or words, then the answer is no, and no alternative suggestion is returned. Control transfers back to operation 406 for examination of the next query word. On the other hand, if one or more of the suggested words is more popular than the user's query word, then the answer in operation 414 is yes, and control transfers to operation 416.

In operation 416, the query suggestion word or n-gram is slated to be returned by the analyzer 108 to the user as an alternative query word and either can be immediately displayed to the user or held until all words in the query have been examined. In either case, control then passes to operation 418 where the analyzer examines for a next query word. Control then transfers to query operation 420.

In query operation 420, the query is made whether there are any more tokenized user query words to be evaluated. If the answer is yes, control transfers again back to operation 406 where the next word is examined. On the other hand, if the answer is no, there are no further words in the user query, control passes to end operation 422, where the alternative query suggestion words, if any remain to be sent, are displayed to the user as alternatives.

Initially all documents are examined and an index of the words occurring in the corpus of documents is generated. When documents are added to the corpus, a new index, popularity table and lexicon may be generated and substituted for the existing index, popularity table and lexicon. Alternatively, these may be updated as new documents are added.

Although the invention has been described in language specific to structural features, methodological acts, and computer readable media containing such acts, it is to be understood that the invention defined in the appended claims is not necessarily limited to the specific structure, acts or media described. Therefore, the specific structure, acts or media are disclosed herein only as preferred forms of implementing the claimed invention. They should not be interpreted as limiting the scope of the present invention. Further, many variations and changes and alternatives will readily suggest themselves to one ordinarily skilled in the art. Accordingly all such variations, changes and alternatives are also within the intended broad scope and meaning of the invention as defined by the appended claims.

What is claimed is:

1. A method of providing alternative query suggestions to a user making a search query in a software application comprising:
generating a popularity table for words in a corpus of documents having a popularity value for each word in the corpus based on occurrences of the word in the corpus;
comparing each entry in the popularity table to suggestions from a word generator;
generating a lexicon of word generator suggestion words that are found in the popularity table; and
submitting each word in the search query to the word generator to determine suggestion words; and
producing one or more of the suggestion words from the lexicon that are more popular than the query word.

2. The method according to claim 1 wherein each value in the popularity table is based on a number of word occurrences in all documents in the corpus.

3. The method according to claim 1 wherein each value in the popularity table is based on the greatest frequency of occurrence of the word in a single document in the corpus.

4. The method according to claim 1 wherein the popularity value for each suggestion word is based on the total number of documents containing the suggestion word.

5. A system for providing alternative query suggestions to a user comprising:
a processor; and
a memory coupled with and readable by the processor and containing a series of instructions that, when executed by the processor, cause the processor to:
analyze each word in a query with a word generator to determine suggestion words;
compare each suggestion word obtained from the word generator to entries in a popularity table of words to determine popular suggestion words; and
providing one or more of the suggestion words that are more popular than the query word.

6. The system according to claim 5 wherein the series of instructions cause the processor analyze each word by:
generating an index of all words in a corpus of documents available to the application;
generating the popularity table having a popularity value for each word in the index based on occurrences of the word in the corpus.

7. The system according to claim 5 wherein the series of instructions cause the processor to:
generate an index of all words in a corpus of documents available to the application;
generate the popularity table for the index having a popularity value for each word in the index based on occurrences of the word in the corpus;
compile a lexicon of word generator suggestion words that are found in the popularity table;
submit each word in the search query to the word generator to determine suggestion words; and
providing one or more of the suggestion words from the lexicon that are more popular than the query word.

8. The system according to claim 7 wherein the popularity table is based on the number of occurrences of the word in all the documents in the corpus.

9. The system according to claim 7 wherein the popularity value for each suggestion word is based on the total number of documents containing the suggestion word.

10. The system according to claim 7 wherein the popularity value for each suggestion word is based on the total number of occurrences of the word within any single document in the corpus.

11. A computer readable medium encoding a computer program of instructions for executing a computer process for providing alternative suggestions to a user query to a user, said computer process comprising:
analyzing each word in the user query with a word generator to determine suggestion words;
comparing each suggestion word obtained from the word generator to entries in a popularity table of words to determine popular suggestion words; and
providing one or more of the suggestion words that are more popular than the query word.

12. The computer readable medium according to claim 11 wherein analyzing comprises:
generating an index of all words in a corpus of documents available to the application;
generating the popularity table having a popularity value for each word in the index based on occurrences of the word in the corpus.

13. The computer readable medium according to claim 12 wherein each value in the popularity table is based on the greatest frequency of occurrence of the word in a single document in the corpus.

14. The computer readable medium according to claim 12 wherein the popularity value for each suggestion word is based on the total number of documents containing the suggestion word.

15. The computer readable medium according to claim 12 further comprising compiling a lexicon of word generator suggestion words that are found in the popularity table.

16. The computer readable medium according to claim 15 wherein each value in the popularity table is based on the greatest frequency of occurrence of the word in a single document in the corpus.

17. The computer readable medium according to claim 15 wherein the popularity value for each word in the popularity table is based on the total number of documents in the corpus containing the word.
